(19) United States
(12) Patent Application Publication
(10) Pub. No.: US 2026/0257353 A1
(43) Pub. Date: Sep. 3, 2026

(54) ROBOT CONTROL DEVICE

(71) Applicant: FANUC CORPORATION, Yamanashi (JP)

(72) Inventor: Wanfeng Fu, Yamanashi (JP)

(21) Appl. No.: 18/993,202

(22) PCT Filed: Oct. 17, 2022
(86) PCT No.: PCT/JP2022/038549

§ 371 Date: Jan. 10, 2025

(51) Int. Cl. B25J 9/16

(52) U.S. Cl. CPC B25J 9/1633

(57) ABSTRACT

This robot control device comprises a force control unit for executing force control on the basis of a detection value of an external force and a prescribed force control parameter, a contact detection unit that is configured so as to be capable of detecting contact between the robot and the external environment, and that executes a prescribed control of the robot when contact is detected, and a force control parameter adjustment unit for adjusting the prescribed force control parameter by executing a plurality of movements of the robot by means of force control, wherein the force control parameter adjustment unit adjusts the prescribed force control parameter while adjusting the sensitivity of the contact detection carried out by the contact detection unit.

### CROSS-REFERENCE TO RELATED APPLICATIONS

This application is a National Stage application of International Application No. PCT/JP2022/038549 filed Oct. 17, 2022.

### BACKGROUND

### Field

The present disclosure relates to a robot control device.

### Discussion of the Related Art

Lead-through teaching in which an operator performs teaching of a robot while directly pushing a robot arm with his/her hand to operate the robot has been known as a teaching method of a robot (for example, see Japanese Unexamined Patent Publication (Kokai) No. 2015-199174 A). In the lead-through teaching, control for causing the robot arm to perform a motion according to an external force applied to the robot arm by an operator is performed.

Force control has been known as one type of a control method of a robot. A robot can be caused to perform high level of work such as fitting work for fitting a workpiece held by a hand attached to a tip of a robot arm into another workpiece, surface alignment work, and search work by applying force control (for example, see Japanese Unexamined Patent Publication (Kokai) No. 2007-237312 A; Japanese Unexamined Patent Publication (Kokai) No. 2016-043457 A and Japanese Unexamined Patent Publication (Kokai) No. 2019-141937 A). Force control parameters that determine a relationship between a force applied to a workpiece and behavior of a robot need to be appropriately set in order to appropriately cause the robot to perform work by force control. Japanese Unexamined Patent Publication (Kokai) No. 2007-237312 A describes one example of a technique for automatically setting a force control gain that is one of force control parameters.

### SUMMARY

A robot that supports direct teaching such as lead-through teaching is generally configured to be able to detect contact between the robot and an external environment in terms of safety of an operator. Regarding such a robot, it is also desired to appropriately set force control parameters so that the robot can appropriately perform work by force control.

A robot control device that can suitably perform an adjustment of force control parameters for controlling a robot configured to be able to detect contact between the robot and an external environment is desired.

An aspect of the present disclosure is a robot control device, and the robot control device includes: a force control unit configured to execute force control, based on a detected value of an external force and a predetermined force control parameter; a contact detection unit configured to be able to detect contact between a robot and an external environment, and execute predetermined control on the robot when the contact is detected; and a force control parameter adjustment unit configured to adjust the predetermined force control parameter by causing the robot to perform operations by the force control for a plurality of times, wherein the force control parameter adjustment unit performs an adjustment of the predetermined force control parameter while adjusting sensitivity of contact detection by the contact detection unit.

The objects, the features, and the advantages, and other objects, features, and advantages will become more apparent from the detailed description of typical embodiments of the present invention illustrated in accompanying drawings.

### BRIEF DESCRIPTION OF DRAWINGS

FIG. 1 is a diagram illustrating a configuration of a robot system according to an embodiment.

FIG. 2 is a diagram illustrating a functional block diagram of a robot control device.

FIG. 3 is a flowchart illustrating an entire flow of parameter adjustment processing.

FIG. 4 is a flowchart illustrating force control parameter automatic adjustment processing.

FIG. 5 is a side view illustrating a posture error between a workpiece and a target object during an automatic adjustment of a force control parameter.

FIG. 6A is a plan view illustrating the posture error between the workpiece and the target object illustrated in FIG. 5.

FIG. 6B is a plan view illustrating the workpiece and the target object in which a posture error direction is different by 90 degrees with respect to FIG. 6A.

FIG. 6C is a plan view illustrating the workpiece and the target object in which the posture error direction is different by 180 degrees with respect to FIG. 6A.

FIG. 6D is a plan view illustrating the workpiece and the target object in which the posture error direction is different by 270 degrees with respect to FIG. 6A.

FIG. 7 is a diagram illustrating a state where a notification screen indicating that force control parameter automatic setting processing is being executed is displayed together with a setting screen for setting a force control parameter.

FIG. 8 is a diagram illustrating a robot sensitivity adjustment screen.

FIG. 9 is a diagram illustrating a state where a notification screen indicating that the force control parameter automatic adjustment processing ends is displayed.

FIG. 10 is a diagram illustrating a state where an indicator indicating adjusted robot sensitivity is displayed on the setting screen.

FIG. 11 is a diagram illustrating a display state of a sensitivity indicator of the robot sensitivity.

### DESCRIPTION OF EMBODIMENTS

Next, embodiments of the present disclosure will be described with reference to drawings. A similar configuration portion or a similar functional portion is denoted by the same reference sign in the referred drawings. A scale is appropriately changed in the drawings in order to facilitate understanding. An aspect illustrated in the drawing is one example for implementing the present invention, and the present invention is not limited to the illustrated aspect.

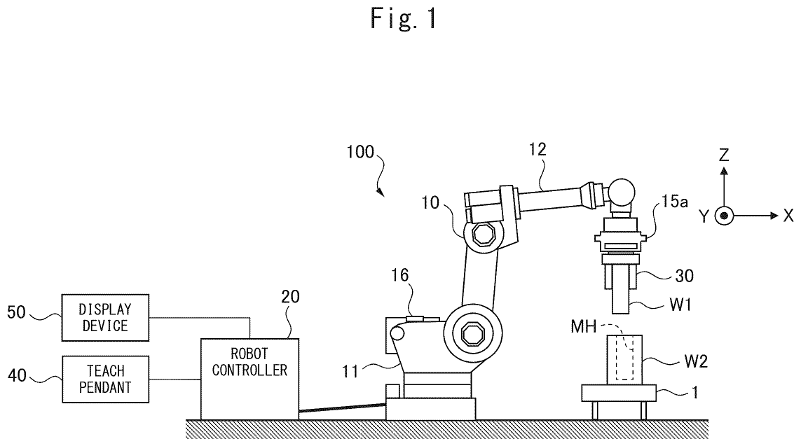

FIG. 1 is a diagram illustrating a configuration of robot system 100 according to an embodiment. Robot system 100 is configured to be able to perform various types of work by force control. As illustrated in FIG. 1, robot system 100 includes robot 10, robot controller 20 that controls robot 10, teach pendant 40 connected to robot controller 20, and hand 30. Further, as illustrated in FIG. 1, robot system 100 may include display device 50 for displaying various types of information related to execution of a motion program. As an exemplification, FIG. 1 illustrates a case where fitting work for fitting workpiece W1 into a fitting hole MH of workpiece W2 on worktable 1 by robot 10 is performed.

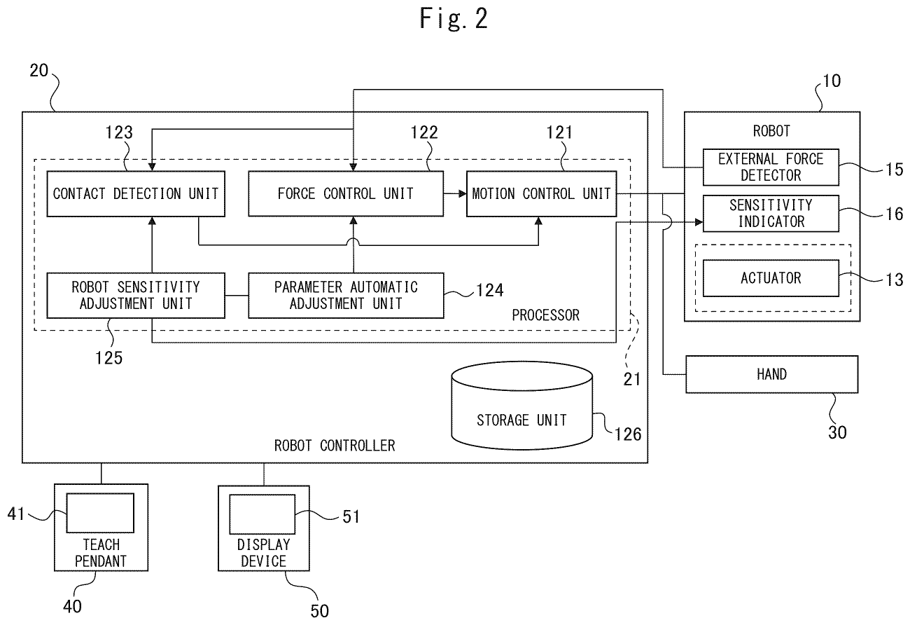

Robot 10 is assumed to be a vertical articulated robot in the present example. It should be noted that a parallel link robot and a robot of another type may be used as robot 10. Robot 10 includes base 11 and robot arm 12 formed of a plurality of link members. A plurality of driving axes of robot arm 12 include actuator 13 (see FIG. 2) including a servo motor.

Hand 30 is attached to an arm tip portion of robot 10. Hand 30 is subjected to driving control by robot controller 20 to hold workpiece W1. In the fitting work, workpieces include workpiece W1 held by hand 30, and workpiece W2 on the worktable. Workpiece W1 has, for example, a cylindrical shape. Workpiece W2 is a target object into which workpiece W1 is fitted by a motion of robot 10. Workpiece W2 has the fitting hole MH for fitting workpiece W1. Workpiece W2 is arranged on worktable 1 in such a way that the fitting hole MH faces upward.

Robot 10 includes external force detector 15 that detects an external force (FIG. 2). External force detector 15 may be formed of a force sensor mounted on robot 10, or may be formed of a torque sensor provided on each axis of robot 10. FIG. 1 illustrates an example in which force sensor 15a that functions as external force detector 15 is mounted on a root portion of hand 30. Force sensor 15a is, for example, a 6-axis force sensor that can detect a force in an X-axis direction, a Y-axis direction, and a Z-axis direction, and moment around the axes. A detected value of external force detector 15 is output to robot controller 20.

In such a manner, by including external force detector 15, robot 10 is configured to be able to perform work (such as fitting work) by force control, and also be able to support direct teaching such as lead-through teaching.

Herein, as a reference, a general robot that includes a force control function and also supports direct teaching will be described. A robot that supports direct teaching such as lead-through teaching is generally configured to be able to detect contact between the robot and an external environment and, for example, stop the robot when the contact is detected in order to ensure safety of an operator during direct teaching. The contact between the robot and the external environment may be detected by, for example, setting a threshold value to an external force applied to the robot, and determining that there is the contact between the robot and the external environment when the external force exceeds the threshold value. A response of the robot changes according to a level of the threshold value, and thus a setting state of the threshold value is also referred to as robot sensitivity. As the robot sensitivity increases (i.e., the threshold value reduces), the robot more sensitively responds to an external force and stops (the robot is to stop even by a small external force). As the robot sensitivity reduces (i.e., the threshold value increases), a response of the robot to an external force becomes slower (the robot does not stop unless a great external force is applied).

In direct teaching, a threshold value is usually set to a value greater than a force applied to a robot, but, in general, robot sensitivity is preferably set high in terms of safety.

Execution of force control in the robot that can detect contact with an external environment as described above is considered. Force control parameters need to be appropriately set in order to appropriately execute the force control as described above. An adjustment of the force control parameter is work having a high level and a high degree of difficulty, and thus adopting a configuration that can automatically adjust the force control parameter is beneficial to a user. When the force control parameter is automatically adjusted, it is general to acquire an adjustment value while the robot is caused to attempt a motion of the force control. Meanwhile, it also needs to be considered that the robot sensitivity may have an influence on behavior of the robot as described above.

In view of the circumstances described above, robot controller 20 according to the present embodiment is configured to be able to perform an adjustment of a force control parameter while adjusting the robot sensitivity as described below in detail.

Robot controller 20 controls the motion of robot 10 according to a motion program or a command from teach pendant 40. Robot controller 20 may have a hardware configuration as a general computer including processor 21 (FIG. 2), a memory (such as a ROM, a RAM, and a non-volatile memory), a storage device, an operation unit, an input/output interface, a network interface, and the like.

Teach pendant 40 is used as an operation terminal for performing teaching of robot 10 and various types of setting. A teaching device formed of a tablet computer and the like may be used as teach pendant 40. Teach pendant 40 may have a hardware configuration as a general computer including a processor, a memory (such as a ROM, a RAM, and a non-volatile memory), a storage device, an operation unit, display unit 41 (FIG. 2), an input/output interface, a network interface, and the like.

Display device 50 provides a function of displaying various types of information related to execution of a motion program. An information processing device such as a personal computer can be used as display device 50. Display device 50 may have a hardware configuration as a general computer including a processor, a memory (such as a ROM, a RAM, and a non-volatile memory), a storage device, an operation unit, display unit 51 (FIG. 2), an input/output interface, a network interface, and the like.

It should be noted that FIG. 1 illustrates the configuration in which display device 50 and teach pendant 40 are provided as separate devices in robot system 100, but the function as display device 50 may be integrally incorporated into teach pendant 40.

FIG. 2 illustrates a functional block diagram of robot controller 20. As illustrated in FIG. 2, robot controller 20 includes motion control unit 121, force control unit 122, contact detection unit 123, parameter automatic adjustment unit 124, robot sensitivity adjustment unit 125, and storage unit 126. It should be noted that the functional blocks of motion control unit 121, force control unit 122, contact detection unit 123, parameter automatic adjustment unit 124, and robot sensitivity adjustment unit 125 may be achieved by processor 21 executing software.

External force detector 15 provided in robot 10 detects an external force applied to robot 10, and provides the detected value to force control unit 122 and contact detection unit 123. Robot 10 includes a sensitivity indicator 16 that displays robot sensitivity. A function of sensitivity indicator 16 will be described below. Each joint axis of robot 10 includes actuator 13.

Teach pendant 40 includes display unit 41. Display unit 41 includes, for example, a liquid crystal display. For example, various types of information related to teaching of robot 10 are displayed on display unit 41.

Display device 50 includes display unit 51. Display unit 51 includes, for example, a liquid crystal display. For example, various types of information related to execution of a motion program are displayed on display unit 51.

Force control unit 122 provides a function of performing a motion by force control by sending a command to motion control unit 121, based on an external force detected by external force detector 15 and force control parameters. The force control parameters are stored in, for example, storage unit 126.

Motion control unit 121 controls a motion of robot 10 according to a command from force control unit 122, contact detection unit 123, and the like. Motion control unit 121 generates a command for actuator 13 of each joint axis by kinematic calculation to execute control of robot 10.

Parameter automatic adjustment unit 124 provides a function of automatically adjusting force control parameters by causing the robot to perform operations by force control for a plurality of times. The force control parameters include a force control gain, a speed command value, a force command value, and the like. Force control unit 122 executes force control according to the force control parameters.

Contact detection unit 123 detects contact between robot 10 and an external environment (such as a human), and executes predetermined control on robot 10 when the contact is detected. Herein, as an exemplification, contact detection unit 123 determines that there is contact between robot 10 and an external environment (such as a human) when magnitude of a force or moment detected by external force detector 15 exceeds a threshold value. The response of robot 10 changes according to a level of the threshold value, and thus a setting state of the threshold value represents sensitivity of contact detection by contact detection unit 123. As described above, the sensitivity of the contact detection (the setting state of the threshold value) is also referred to as robot sensitivity. The predetermined control is control for stopping robot 10, setting robot 10 in a state at a sufficiently low speed, and the like. Hereinafter, the predetermined control is assumed to be the control for stopping robot 10.

Robot sensitivity adjustment unit 125 provides a function of changing a threshold value (i.e., robot sensitivity) for detecting that there is contact between robot 10 and an external environment by contact detection unit 123.

Reducing the threshold value is associated with increasing the robot sensitivity. It should be noted that, when the robot sensitivity is high, the robot sensitively responds to an external force and stops by a relatively small force (external force).

Increasing the threshold value is associated with reducing the robot sensitivity. It should be noted that, when the robot sensitivity is low, the robot slowly responds to an external force, and does not stop unless a relatively great force is applied.

By the configuration described above, in both of a case where work (such as fitting work) by force control is performed and a case where lead-through teaching in which an operator performs teaching by directly applying a force to an arm and the like of robot 10 is performed, robot 10 is stopped and safety of an operator can be ensured when contact between robot 10 and an external environment is detected. It should be noted that, in lead-through teaching, force control unit 122 generates a motion command in such a way that robot 10 moves in the direction of an external force detected by external force detector 15 (a direction of a force applied to robot 10 by the operator).

Storage unit 126 stores a motion program, force control parameters, robot sensitivity, various types of setting information, and the like. Storage unit 126 may be formed of a non-volatile memory, a storage device, and the like.

An automatic adjustment of a force control parameter may be affected by robot sensitivity. For example, when the robot sensitivity is high (i.e., when the threshold value described above is low), an external force is more likely to exceed a limit value (the threshold value described above), and the robot tends to sensitively respond to the external force, and thus a motion of the robot is more likely to be unstable. Further, in this case, the robot controller cannot support force control that requires a great pressing force. In view of the above-described influence of the robot sensitivity on an adjustment of the force control parameter, parameter automatic adjustment unit 124 is configured, when the parameter adjustment fails, to confirm the robot sensitivity and adjust the robot sensitivity, and perform the parameter adjustment again. In this way, an appropriate automatic adjustment of the force control parameter can be achieved, and the robot sensitivity with respect to the force control parameter can also be set to an optimum state.

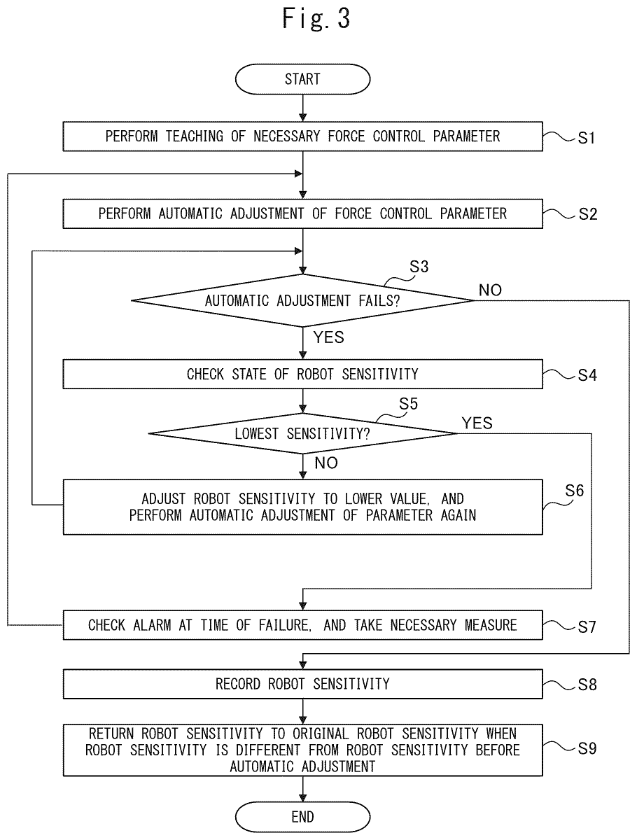

FIG. 3 is a flowchart illustrating an entire flow of parameter adjustment processing according to the present embodiment. Parameter automatic adjustment unit 124 functions as a force control parameter adjustment unit for controlling the present parameter adjustment processing. First, teaching of a necessary force control parameter is performed by an operator (step S1). Herein, for example, the operator performs an input of the force control parameter via a setting screen (user interface). The force control parameter input by the operator is stored in storage unit 126.

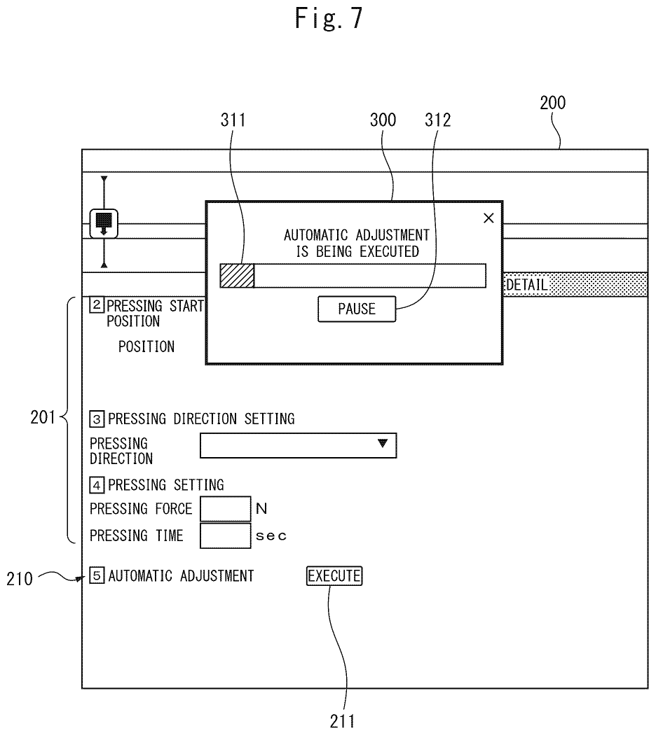

FIG. 7 illustrates a setting screen 200 for setting the force control parameter. The setting screen 200 includes an input column 201 for inputting the force control parameter. The operator can perform teaching of the force control parameter by inputting a value in the input column 201. Parameter automatic adjustment unit 124 may have a function of presenting such a setting screen. Such a setting screen may be displayed on display unit 51 of display device 50, or may be displayed on display unit 41 of teach pendant 40.

Next, force control parameter automatic adjustment processing by parameter automatic adjustment unit 124 is executed (step S2). A column 210 for activating the force control parameter automatic adjustment processing may be provided in the setting screen 200. In this case, the operator can activate the force control parameter automatic adjustment processing by pressing an execution button 211. When the force control parameter automatic adjustment processing is activated, a notification screen 300 indicating that the force control parameter automatic adjustment processing is executed may be presented. In the present example, an indicator 311 indicating a degree of progress of the force control parameter automatic adjustment processing in a bar graph form, and a pause instruction button 312 are included in the notification screen 300.

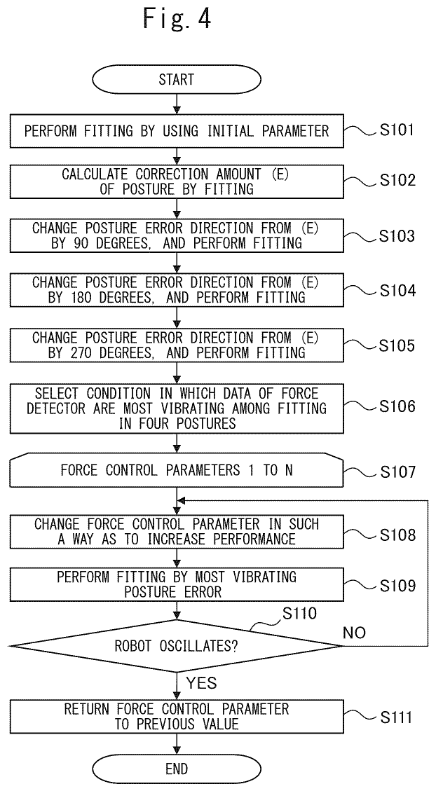

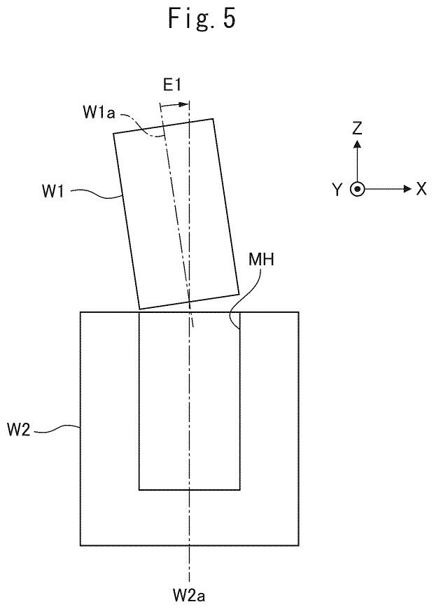

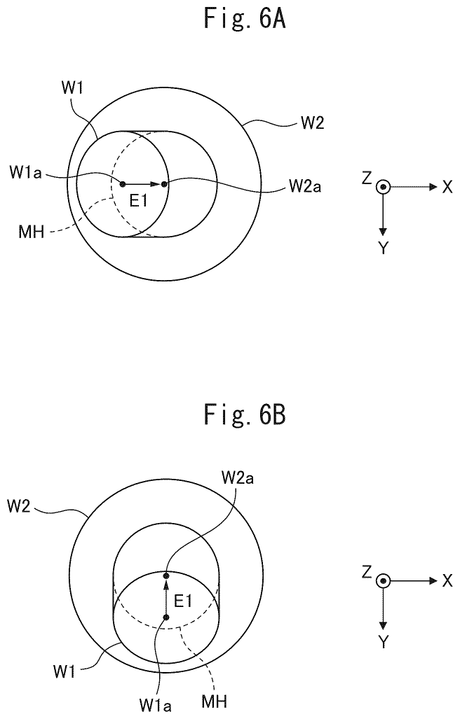

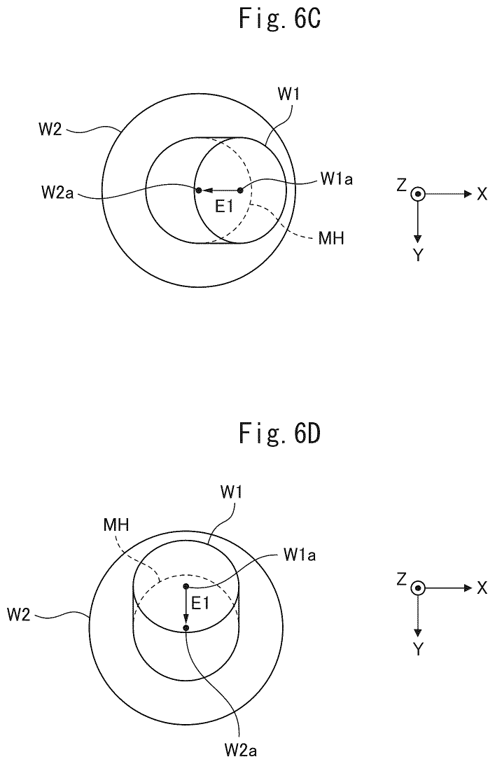

FIG. 4 is a flowchart illustrating the force control parameter automatic adjustment processing. The force control parameter automatic adjustment processing by parameter automatic adjustment unit 124 will be described with reference to the flowchart illustrated in FIG. 4, FIG. 5, and FIGS. 6A to 6D. The force control parameter automatic adjustment is performed, for example, when a robot system is set up, when a type of workpiece is changed, when a hand is exchanged, or the like. Herein, a case where a fitting motion of fitting workpiece W1 held by hand 30 into a fitting hole of workpiece W2 is performed will be described as an example. The parameter automatic adjustment processing is executed by force control unit 122 and motion control unit 121 under control by parameter automatic adjustment unit 124.

When the present processing is activated, first, parameter automatic adjustment unit 124 reads an initial parameter of force control from storage unit 126. Force control unit 122 outputs a command to robot 10 and executes a first operation of causing robot 10 to perform a motion in such a way as to fit workpiece W1 held by hand 30 into the fitting hole MH of workpiece W2, based on the initial parameter (step S101).

FIG. 5 is a side view illustrating a state immediately before workpiece W1 held by hand 30 is fitted into the fitting hole MH of workpiece W2 by the force control of robot 10 by the initial parameter. FIG. 6A is a plan view of this state. As illustrated in FIGS. 5 and 6A, when the force control is performed on robot 10 based on the initial parameter, robot 10 has a posture in which workpiece W1 is obliquely positioned with respect to the fitting hole MH. Specifically, an axis line W1a of workpiece W1 is tilted by an angle E1 in the −X axis direction (left direction in FIGS. 5 and 6A) around Y axis with respect to an axis line W2a of the fitting hole MH of workpiece W2.

Robot 10 needs to have a posture in which the axis line W1a of workpiece W1 and the axis line W2a of the fitting hole MH coincide with each other in order to appropriately fit workpiece W1 into the fitting hole MH. Thus, the angle E1 represents a posture error needed to be corrected by robot 10 at the time of start of the fitting. The angle E1 is a change amount of a posture of robot 10 needed for properly fitting workpiece W1 into the fitting hole MH, i.e., a correction amount (E) of the posture error.

Herein, when a rotation matrix representing a robot posture at the time of start of the fitting is TA and a rotation matrix representing a robot posture after the fitting is TB, inv (TB)×TA is a rotation matrix representing the correction amount (E) of the posture error at the time of start. In this case, inv represents an inverse matrix. Parameter automatic adjustment unit 124 calculates the correction amount (E) of the posture error, and stores the correction amount (E) in storage unit 126 (step S102).

It should be noted that a threshold value of the correction amount of the posture error is preset in parameter automatic adjustment unit 124. When an absolute value of the correction amount (E) of the posture error calculated in step S102 is equal to or less than the threshold value, parameter automatic adjustment unit 124 sets the correction amount (E) of the posture error to a predetermined value. The setting is performed in order to intentionally provide the posture error when there is no posture error or when the posture error is too small. The predetermined value is, for example, the threshold value. In other words, when the threshold value is set to 0.5 degrees and the correction amount of the posture error calculated in step S102 is equal to or less than 0.5 degrees, the correction amount (E) of the posture error is set to 0.5 degrees.

Next, force control unit 122 changes a posture error direction and executes a second fitting motion in the same position as that at the time of execution of the first fitting motion and with the same absolute value as that of the correction amount (E) of the posture error of robot 10 (step S103).

In step S103, parameter automatic adjustment unit 124 executes fitting from a posture indicated by a rotation matrix of TB×T (90)×inv (TB)×TA. T (90) is a matrix of rotation by 90 degrees around a fitting direction (around the axis line W2a of the fitting hole MH) with respect to the first fitting motion. In this way, as illustrated in FIG. 6B, robot 10 performs the fitting from a position in which the axis line W1a of workpiece W1 is tilted by the angle E1 in the +Y axis direction (downward direction in FIG. 6B) around X axis with respect to the axis line W2a of the fitting hole MH of workpiece W2.

Next, force control unit 122 changes the posture error direction again and executes a third fitting motion in the same position as that at the time of execution of the second fitting motion and with the same absolute value as that of the correction amount (E) of the posture error of robot 10 (step S104).

In step S104, parameter automatic adjustment unit 124 executes fitting from a posture indicated by a rotation matrix of TB×T (180)×inv (TB)×TA. T (180) is a matrix of rotation by 180 degrees around the fitting direction (around the axis line W2a of the fitting hole MH) with respect to the first fitting motion. In this way, as illustrated in FIG. 6C, robot 10 performs the fitting from a position in which the axis line W1a of workpiece W1 is tilted by the angle E1 in the +X axis direction (right direction in FIG. 6C) around Y axis with respect to the axis line W2a of the fitting hole MH of workpiece W2.

Next, force control unit 122 changes the posture error direction again and executes a fourth fitting motion in the same position as that at the time of execution of the third fitting motion and with the same absolute value as that of the correction amount (E) of the posture error of robot 10 (step S105).

In step S105, parameter automatic adjustment unit 124 executes fitting from a posture indicated by a rotation matrix of TB×T (270)×inv (TB)×TA. T (270) is a matrix of rotation by 270 degrees around the fitting direction (around the axis line W2a of the fitting hole MH) with respect to the first fitting motion. In this way, as illustrated in FIG. 6D, robot 10 performs the fitting from a position in which the axis line W1a of workpiece W1 is tilted by the angle E1 in the −Y axis direction (upward direction in FIG. 6D) around X axis with respect to the axis line W2a of the fitting hole MH of workpiece W2.

In each fitting motion from the first fitting motion to the fourth fitting motion, parameter automatic adjustment unit 124 records a detected value output from external force detector 15 via force control unit 122. After the fitting motion in the four directions (four postures) ends, parameter automatic adjustment unit 124 obtains a vibration amount from the detected value of external force detector 15 at the time of each fitting motion, and selects a direction (posture) in which data of the detected value are the most vibrating (step S106).

As a method for obtaining a vibration amount, there is, for example, a method for performing a Fourier transform on a detected value of external force detector 15, and obtaining an amplitude of a specific frequency, based on the result. Further, a vibration amount may be obtained by obtaining a maximum value or an average value of a change amount of a detected value of external force detector 15.

Parameter automatic adjustment unit 124 selects the direction (posture) in which the data of the detected value of external force detector 15 are the most vibrating in step S106, and then obtains force control parameters 1 to N adjusted only by the posture error of the selected direction (posture) (step S107), and changes each of the force control parameters in such a way as to increase performance (step S108). N is the number of types of the force control parameter. The types of the force control parameter are a force control gain, a speed command value, a force command value, and the like. An adjustment of the force control parameter may be performed on the parameters for each type, or may be simultaneously performed on a plurality of types of the parameter.

After the force control parameter is changed in step S108 in such a manner, force control unit 122 causes robot 10 to perform a motion in such a way as to fit workpiece W1 into the fitting hole MH of workpiece W2 again with the posture error in the most vibrating direction (posture) among the fitting motions in the four directions (four postures) (step S109).

When the force control parameter is changed too much in such a way as to improve performance of force control, instability of robot 10 such as an increase in a vibration is more likely to be caused. For example, when a force control gain is increased, a response to a generated force is faster, and thus correction of a posture error at a time of fitting is faster, and a time required for the fitting is shorter. On the other hand, when the force control gain is increased too much, noise is amplified and robot 10 may oscillate. Thus, parameter automatic adjustment unit 124 executes the fitting motion in step S109, and then obtains a vibration amount from the detected value of external force detector 15 by the method described above, and decides whether robot 10 is oscillating (step S110). It should be noted that whether robot 10 has oscillated can be decided from a vibration amount being greater than a vibration amount at the time of a previous parameter automatic adjustment, exceeding a threshold value of a preset vibration amount, or the like.

When it is decided that robot 10 is not oscillating in step S110 (step S110: NO), parameter automatic adjustment unit 124 returns to the processing from step S108. In other words, parameter automatic adjustment unit 124 changes the force control parameter in such a way as to further increase performance of the force control parameter, and then executes a fitting motion again with the most oscillating posture error. Then, in step S110, whether robot 10 is oscillating is decided again. The processing in step S108 and step S109 is repeated until it is decided that robot 10 is oscillating in step S110.

On the other hand, when it is decided that robot 10 is oscillating in step S110 (step S110: YES), parameter automatic adjustment unit 124 returns the changed force control parameter to a previous value (step S111).

In this way, the force control parameter is set to a limit value at which robot 10 does not oscillate. Parameter automatic adjustment unit 124 outputs and overwrites the set force control parameter to storage unit 126, and then ends the force control parameter automatic adjustment processing.

It should be noted that, herein, the example of performing an automatic adjustment of a force control parameter by executing movement of workpiece W1 from a plurality of posture error directions is described, but a force control parameter may be automatically adjusted by executing movement of workpiece W1 from a plurality of position error directions and posture error directions.

When the force control parameter automatic adjustment processing described above normally proceeds from step S101 to S111, and the processing ends, parameter automatic adjustment unit 124 decides that the automatic adjustment succeeds. On the other hand, when the force control parameter automatic adjustment processing does not normally end in the process from step S101 to S111, and an automatic adjustment value of the force control parameter is not acquired, parameter automatic adjustment unit 124 decides that the automatic adjustment fails, and interrupts and ends the force control parameter automatic adjustment processing.

Returning to the description in FIG. 3, next, parameter automatic adjustment unit 124 confirms whether the automatic adjustment fails (step S3).

When parameter automatic adjustment unit 124 determines that the automatic adjustment fails (S3: YES), the processing proceeds to step S4. In step S4, parameter automatic adjustment unit 124 confirms robot sensitivity.

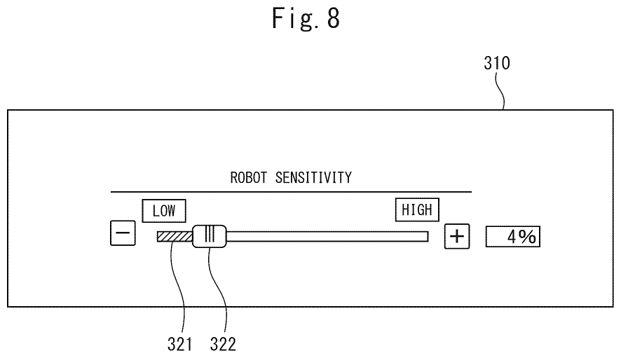

When the robot sensitivity is not the lowest robot sensitivity (S5: NO), parameter automatic adjustment unit 124 reduces the robot sensitivity, and executes the force control parameter automatic adjustment processing again (step S6). When an automatic adjustment of the robot sensitivity is performed, parameter automatic adjustment unit 124 may display a sensitivity adjustment screen 310 as illustrated in FIG. 8 the robot sensitivity adjustment unit 125. In this case, the operator can observe a situation in which the robot sensitivity is adjusted. The sensitivity adjustment screen 310 illustrated in FIG. 8 indicates a setting state of the robot sensitivity by a length of a bar 321 (a position of a button 322). It should be noted that the sensitivity adjustment screen 310 may be displayed on a display screen together with the setting screen 200 as in FIG. 7.

When the force control parameter automatic adjustment executed again ends, the processing from step S3 is executed.

When the robot sensitivity is the lowest robot sensitivity (S5: YES), the operator confirms an alarm content and the like output when the force control parameter automatic adjustment processing fails and ends, performs a necessary adjustment to execute the processing from step S2 (step S7).

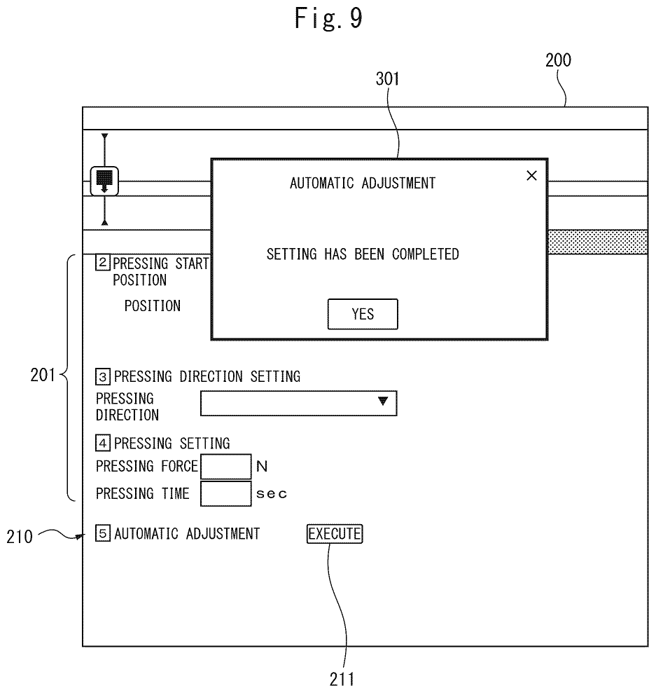

When the force control parameter automatic adjustment processing succeeds (S3: NO), the processing proceeds to step S8. At this time, as illustrated in FIG. 9, a notification screen 301 indicating that the force control parameter automatic adjustment processing ends may be displayed on the display screen. In step S8, parameter automatic adjustment unit 124 records the adjusted robot sensitivity in, for example, storage unit 126 (step S8).

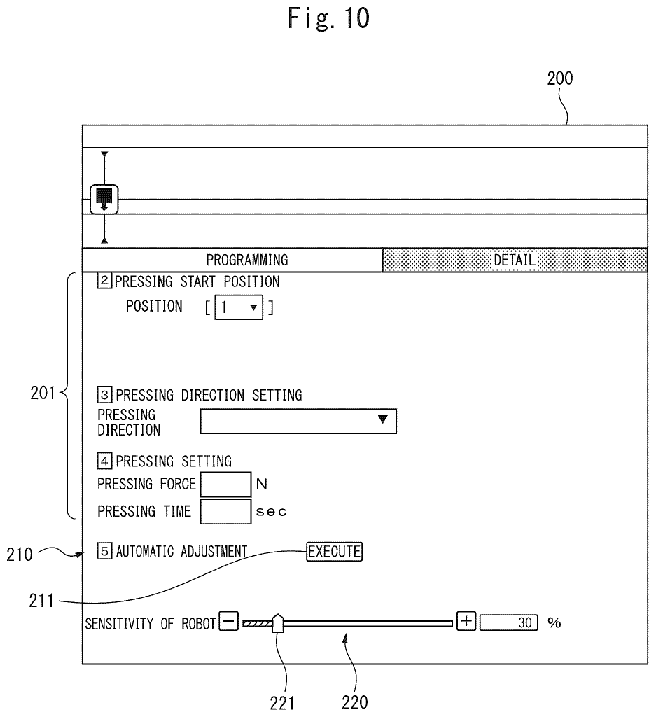

At this time, parameter automatic adjustment unit 124 may display an image indicating the adjusted robot sensitivity. FIG. 10 illustrates an example in which an indicator 220 indicating the adjusted robot sensitivity is displayed on the setting screen 200. In this way, the operator can visually instantly recognize how the robot sensitivity has changed as a result of the automatic adjustment.

When the robot sensitivity set in the automatic adjustment is different from the robot sensitivity before the automatic adjustment is performed, parameter automatic adjustment unit 124 returns the robot sensitivity to the robot sensitivity before the automatic adjustment (step S9).

According to the parameter adjustment processing described above, the robot sensitivity can be set to an appropriate value while an automatic adjustment of the force control parameter to an appropriate value is achieved. Therefore, the force control parameter that achieves high performance can be efficiently acquired. Further, according to the configuration described above, the robot sensitivity can be set to a high value within a range in which an automatic adjustment of the force control parameter succeeds. Therefore, setting of the robot sensitivity in consideration of safety in an automatic adjustment of the force control parameter is achieved. In other words, according to the configuration described above, appropriate setting of the force control parameter and the robot sensitivity can be efficiently performed, and therefore the set-up of the robot system can be efficiently carried out.

The robot sensitivity recorded in step S8 is used when work (the fitting work in the example described above) of force control being a target of the parameter adjustment is performed. In other words, when the work (the fitting work in the example described above) of the force control being the target of the parameter adjustment is performed in a subsequent stage, force control unit 122 changes the robot sensitivity to the recorded robot sensitivity, and executes the force control. Then, when the work by the force control is completed, the robot sensitivity is returned to an original state before the work is performed by the force control. In this way, time and effort for the operator to manually adjust the robot sensitivity are eliminated, and a working burden on the operator can be reduced.

The setting screen 200 in FIG. 10 may be configured to allow an operator to adjust the robot sensitivity by operating a button 221 of the indicator 220. For example, when a further reduction in a cycle time is required, the operator may set the robot sensitivity to a lower value to execute the force control parameter automatic adjustment processing again.

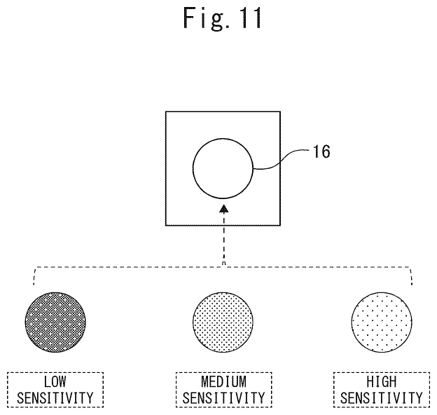

Robot sensitivity adjustment unit 125 may be configured to display current robot sensitivity in the sensitivity indicator 16 provided on the robot 10. The sensitivity indicator 16 may be, for example, an LED lamp. In this case, as illustrated in FIG. 11, robot sensitivity adjustment unit 125 may perform control in such a way that brightness of the LED lamp is increased with higher robot sensitivity. The sensitivity indicator 16 may be arranged in, for example, a position such as base 11 of robot 10 that the operator easily visually recognizes. The operator who operates robot 10 can instantly recognize the robot sensitivity by the sensitivity indicator 16, and thus display of the robot sensitivity by the sensitivity indicator 16 can contribute to an improvement in safety of work.

It should be noted that the display of the robot sensitivity by the sensitivity indicator 16 may be performed during adjustment processing of the force control parameter, or may be always performed during operation of robot 10. As a display style of the sensitivity by the sensitivity indicator 16, a display style other than sensitivity display by brightness may be adopted.

The arrangement of the functions in the functional block diagram illustrated in FIG. 2 is an example, and various modification examples of an arrangement of the functional blocks are possible. For example, an example in which a part of the functional blocks arranged in the robot controller in the functional block diagram in FIG. 2 is arranged in the teach pendant or the display device is also possible.

The functional block of the robot controller illustrated in FIG. 2 may be achieved by executing various types of software stored in a storage device by the processor of the robot controller, or may be achieved by a configuration in which hardware such as an application specific integrated circuit (ASIC) is a main body.

The program for executing various types of processing such as the parameter adjustment processing (FIG. 2) and the parameter automatic adjustment processing (FIG. 3) in the embodiment described above can be recorded in various computer-readable recording media (for example, a ROM, an EEPROM, a semiconductor memory such as a flash memory, a magnetic recording medium, and an optical disk such as a CD-ROM and a DVD-ROM).

As described above, according to the present embodiment, the force control parameter can be adjusted to an appropriate value, and the robot sensitivity can also be appropriately adjusted.

Although the present disclosure has been described above in detail, the present disclosure is not limited to the individual embodiments described above. Various types of addition, replacement, modification, partial deletion, and the like may be made to the embodiments without departing from the purpose of the present disclosure or without departing from the contents described in the claims and the scope of the present disclosure derived from equivalents thereof. Further, the embodiments can be performed in combination. For example, in the embodiments described above, an order of operations and an order of pieces of processing are indicated as one example, which is not limited thereto. Further, the same also applies to a case where a numerical value or a numerical expression is used in the description of the embodiments described above.

With regard to the embodiments and the modification examples described above, supplementary notes below are further described.

### Supplementary Note 1

A robot controller including:
a force control unit configured to execute force control, based on a detected value of an external force and a predetermined force control parameter;
a contact detection unit configured to be able to detect contact between a robot and an external environment, and execute predetermined control on the robot when the contact is detected; and
a force control parameter adjustment unit configured to adjust the predetermined force control parameter by causing the robot to perform operations by the force control for a plurality of times, wherein
the force control parameter adjustment unit that performs an adjustment of the predetermined force control parameter while adjusting sensitivity of contact detection by the contact detection unit.

### Supplementary Note 2

The robot controller according to supplementary note 1, wherein
the force control parameter adjustment unit reduces the sensitivity of contact detection when an adjustment of the force control parameter fails, and repeats a motion of performing an adjustment of the force control parameter again until an adjustment of the force control parameter succeeds.

### Supplementary Note 3

The robot controller according to supplementary note 1 or 2, wherein
the force control parameter adjustment unit records the sensitivity of contact detection at a time of success of an adjustment of the force control parameter.

### Supplementary Note 4

The robot controller according to any one of supplementary notes 1 to 3, wherein,
after success of an adjustment of the force control parameter, the force control parameter adjustment unit returns the sensitivity of contact detection to an original state before the adjustment of the force control parameter is performed.

### Supplementary Note 5

The robot controller according to supplementary note 3, wherein,
when the force control is executed, the force control unit changes the sensitivity of contact detection to the recorded sensitivity of contact detection.

### Supplementary Note 6

The robot controller according to supplementary note 5, wherein,
after execution of the force control, the force control unit returns the sensitivity of the robot to a state before execution of the force control.

### Supplementary Note 7

The robot controller according to any one of supplementary notes 1 to 6, wherein
the force control parameter adjustment unit displays a user interface screen for displaying the sensitivity of contact detection at a time of success of the adjustment of the force control parameter.

### Supplementary Note 8

The robot controller according to supplementary note 7, wherein
the user interface screen is configured to accept a user operation of adjusting the sensitivity of contact detection, and an instruction for performing an adjustment of the force control parameter by the force control parameter adjustment unit again with the sensitivity of contact detection adjusted by the user operation.

### Supplementary Note 9

The robot controller according to any one of supplementary notes 1 to 8, wherein
the force control parameter adjustment unit sends a signal for adjusting brightness of a sensitivity indicator provided on the robot according to the sensitivity of contact detection being currently applied to the robot.

### REFERENCE SIGNS LIST

10 Robot
11 Base
12 Robot arm
13 Actuator
15 External force detector
16 Sensitivity indicator
20 Robot controller
21 Processor
30 Hand
40 Teach pendant
41 Display unit
50 Display device
51 Display unit
100 Robot system
121 Motion control unit
122 Force control unit
123 Contact detection unit
124 Parameter automatic adjustment unit
200 Setting screen
220 Indicator
300, 301 Notification screen
310 Sensitivity adjustment screen

1. A robot controller comprising:
a force control unit configured to execute force control, based on a detected value of an external force and a predetermined force control parameter;
a contact detection unit configured to be able to detect contact between a robot and an external environment, and execute predetermined control on the robot when the contact is detected; and
a force control parameter adjustment unit configured to adjust the predetermined force control parameter by causing the robot to perform operations by the force control for a plurality of times, wherein the force control parameter adjustment unit performs an adjustment of the predetermined force control parameter while adjusting sensitivity of contact detection by the contact detection unit.

2. The robot controller according to claim 1, wherein the force control parameter adjustment unit reduces the sensitivity of contact detection when the adjustment of the force control parameter fails, and repeats performing an adjustment of the force control parameter until an adjustment of the force control parameter succeeds.

3. The robot controller according to claim 1, wherein the force control parameter adjustment unit records the sensitivity of contact detection at a time of success of an adjustment of the force control parameter.

4. The robot controller according to claim 1, wherein after success of an adjustment of the force control parameter, the force control parameter adjustment unit returns the sensitivity of contact detection to an original state before the adjustment of the force control parameter is performed.

5. The robot controller according to claim 3, wherein when the force control is executed, the force control unit changes the sensitivity of contact detection to the recorded sensitivity of contact detection.

6. The robot controller according to claim 5, wherein after execution of the force control, the force control unit returns the sensitivity of the robot to a state before execution of the force control.

7. The robot controller according to claim 1, wherein the force control parameter adjustment unit displays a user interface screen for displaying the sensitivity of contact detection at a time of success of the adjustment of the force control parameter.

8. The robot controller according to claim 7, wherein the user interface screen is configured to accept a user operation of adjusting the sensitivity of contact detection, and an instruction for performing an adjustment of the force control parameter by the force control parameter adjustment unit again with the sensitivity of contact detection adjusted by the user operation.

9. The robot controller according to claim 1, wherein the force control parameter adjustment unit sends a signal for adjusting brightness of a sensitivity indicator provided on the robot according to the sensitivity of contact detection being currently applied to the robot.
